(19) United States
(12) Patent Application Publication
(10) Pub. No.: US 2026/0103280 A1
(43) Pub. Date: Apr. 16, 2026

(54) HYBRID AIR VEHICLE

(71) Applicant: Tusas- Turk Havacilik Ve Uzay Sanayii Anonim Sirketi, Kahramankazan, Ankara (TR)

(72) Inventor: Hasan IBACOGLU, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/115,978

(22) PCT Filed: Sep. 25, 2023
(86) PCT No.: PCT/TR2023/051019

§ 371 Date: Mar. 27, 2025

(30) Foreign Application Priority Data
Sep. 30, 2022 (TR) 2022/015043

(51) Int. Cl. B64C 29/00; B64C 3/40; B64C 3/54; B64C 27/467; B64C 27/605; B64C 27/82; B64C 39/12

(52) U.S. Cl. CPC B64C 29/00; B64C 3/40; B64C 3/54; B64C 27/467; B64C 27/605; B64C 27/82; B64C 39/12; B64C 2003/543; B64C 2027/8263

(57) ABSTRACT

The present invention relates to a body (2) on the air vehicle; at least one motor (3) which provides required power for the flight of the body (2); at least one rotor (4) extending outward from the body (2), connected to the motor (3), and rotating around itself; a plurality of blades (5) located on the rotor (4); a helicopter mode (H) in which the body (2) performs tasks such as vertical landing and take-off, autorotation and hovering; an anti-torque system (6) on the body (2), which creates anti-torque when the body (2) is in helicopter mode (H); an airplane mode (A) in which the rotor (4) is stopped and the blades (5) are used as fixed wings; at least one propulsion system (7) that provides thrust for the movement of the body (2) when the body (2) is in airplane mode (A); a transition mode (T) in which the rotor (4) is stopped and the propulsion system (7) is activated while the body (2) is switched from helicopter mode (H) to airplane mode (A); at least one canard (8) located in the nose area of the body (2) and providing lift to the body (2).

This invention relates to an air vehicle with multiple flight modes.

Multi-mode air vehicles, e.g. with a helicopter mode or an airplane mode, such as hybrid or composite air vehicles that can perform multiple missions during a flight, are suitable for flight and wide mission capabilities. The multi-mode air vehicles are developed to take off and land vertically as helicopters, and thus to be used in rough or small areas. In addition, vehicles with multiple flight modes can operate in the airplane mode to reach high speeds during the flight. According to the known-state of the art, various studies focus on stopping rotor and blades to use them as a fixed wing, in order to switch from the helicopter mode to the airplane mode.

U.S. Pat. No. 5,454,530, which is included in the known-state of the art, discloses an air vehicle with a first flight mode and a second flight mode, in which the air vehicle flies in an helicopter mode and an airplane mode. In addition, the air vehicle has an intermediate flight regime between the first flight regime and the second flight regime, and a canard structure is provided on the air vehicle in order to provide lifting force to the air vehicle during the intermediate flight regime.

The air vehicle according to the present invention has vertical take-off and landing helicopter capabilities, as well as floating in the air like an airplane, such that the rotating rotor is stopped in the air to function as a wing in order to travel faster and stay in the air for a longer period of time, wherein the telescopic control surfaces of the canard located on the nose of the air vehicle increase the aerodynamic properties of the air vehicle during flight.

Object of the present invention is to provide additional lift to the air vehicle when the air vehicle is in airplane mode, helicopter mode and transition mode.

A hybrid air vehicle realized to achieve the object of the invention, which is defined in the first claim and other claims dependent thereon, comprises a body; at least one motor that provides required power for the movement of the body; at least one rotor located on the body to move relative to the body; a plurality of blades on the rotor; a helicopter mode in which the body performs tasks such as vertical take-off and landing, autorotation and hovering; an anti-torque system which is positioned at the rear part of the body with respect to the movement direction of the body, and which creates anti torque on the body relative to the rotor when the body is in helicopter mode; an airplane mode in which rotation of the rotor is stopped to use the blades as fixed wings; at least one propulsion system that provides required power for the movement of the body, when the body is switched to the airplane mode; a transition mode in which the rotor is stopped and the propulsion system is enabled while the body is switched from airplane mode to helicopter mode, or in which the rotor is operated and the propulsion system is disabled while switching from helicopter mode to airplane mode; at least one canard located at the front part of the body with respect to the movement direction thereof, and providing extra lift to the body.

The hybrid air vehicle according to the invention comprises at least one control surface located in the canard so as to move out of the canard in a situation predetermined by the user; a closed position (C) in which the control surface is located almost completely in the canard; an open position (O) to which the control surface is moved from the closed position (C) such that the control surface extends from the canard by a user or by an autonomous movement when the body is in helicopter mode, transition mode, or airplane mode.

In an embodiment of the invention, the hybrid air vehicle comprises the control surface that provides additional lift to the body by moving telescopically from the closed position (C) to the open position (O) only when the body enters transition mode.

In an embodiment of the invention, the hybrid air vehicle comprises the control surface which, in the transition mode, extends to the sides of the air vehicle along the direction of the canard and creates additional lift on the body by increasing the width of the canard.

In an embodiment of the invention, the hybrid air vehicle comprises the control surface which extends out from the trailing edge of the canard to function as a flap, and can be reinserted into the canard if not needed.

In an embodiment of the invention, the hybrid air vehicle comprises at least one vertical stabilizer that provides an anti-torque to the body in the transition mode and/or the airplane mode when values such as flight speed and altitude are achieved, thereby eliminating the need for anti-torque generated by the anti-torque system.

In an embodiment of the invention, the hybrid air vehicle comprises a control unit which enables the air vehicle to be automatically switched from helicopter mode to airplane mode or from airplane mode to helicopter mode when the body reaches user-provided input or predetermined values.

In an embodiment of the invention, the hybrid air vehicle comprises the control unit which enables the control surface to be in the closed position (C) during the helicopter mode, and enables the control surface to switch from the closed mode to open mode when the body is in the transition mode, wherein the control unit enables the control surface to move from the open position (O) to the closed position (C) by telescopic movement on the canard when the body is switched to airplane mode.

In an embodiment of the invention, the hybrid air vehicle comprises the anti-torque system which is triggered by the control unit when switched from helicopter mode to airplane mode, such that it moves with actuator mechanisms on the body, thereby providing thrust to the body.

In an embodiment of the invention, the hybrid air vehicle comprises the canard that can rotate around an axis where they are attached to the body, thereby allowing the body to be directed in helicopter, airplane and/or transition modes.

In an embodiment of the invention, the hybrid air vehicle comprises a swashplate which controls the movement of the blades when the body is in airplane mode, so that the body is directed.

In an embodiment of the invention, the hybrid air vehicle comprises the blade in an elliptical form.

The hybrid air vehicle realized to achieve the object of the present invention is illustrated in the attached drawings, in which:

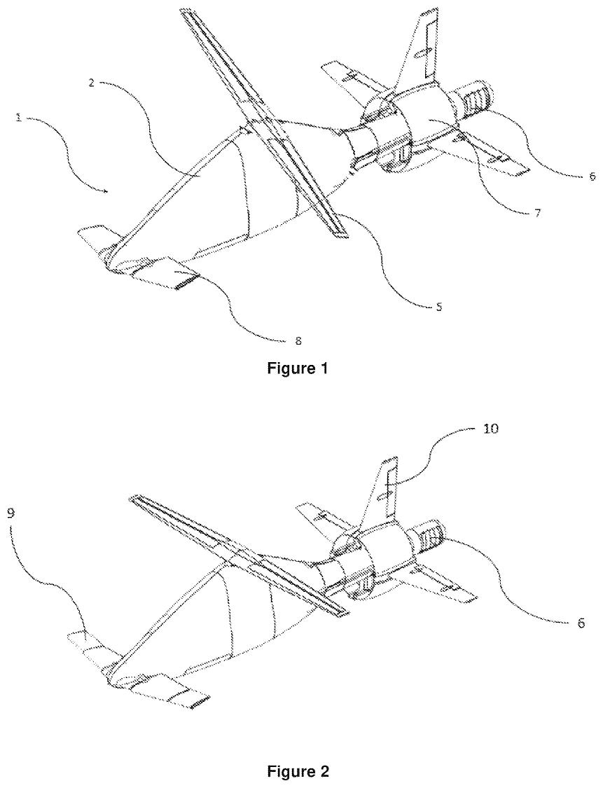

FIG. 1 is a perspective view of the air vehicle in helicopter mode and the control surface in the closed position (C).

FIG. 2 is a perspective view of the air vehicle in transition mode and the control surface in the open position (A).

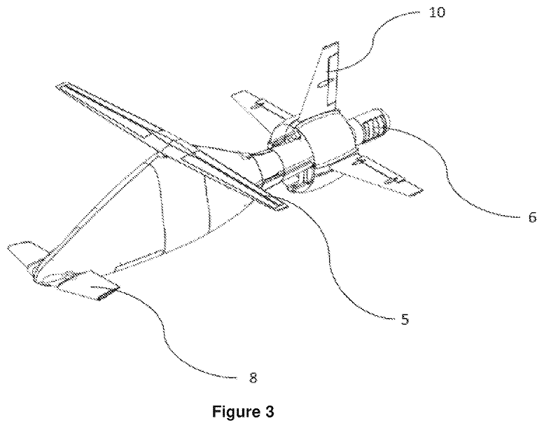

FIG. 3 is a perspective view of the air vehicle in airplane mode.

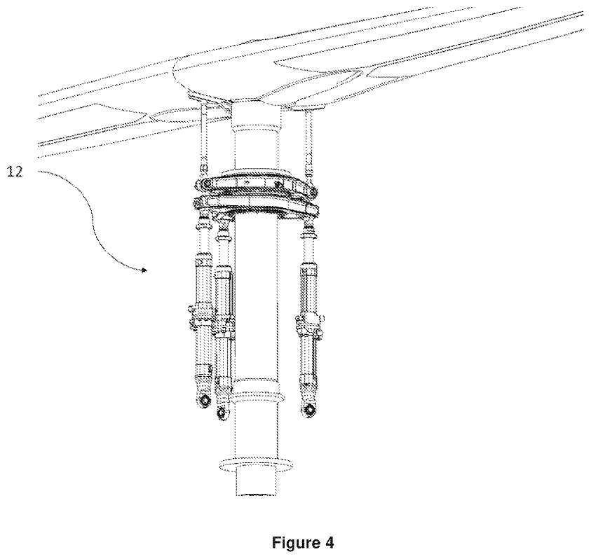

FIG. 4 is a side view of the swashplate and blades.

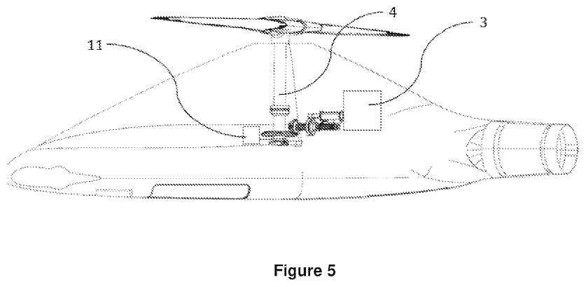

FIG. 5 is a schematic view of the control unit and motor.

All the parts illustrated in figures are individually assigned a reference numeral and the corresponding terms of these numbers are listed below:
1. Hybrid Air Vehicle
2. Body
3. Motor
4. Rotor
5. Blade
6. Anti-torque System
7. Propulsion System
8. Canard
9. Control Surface
10. Vertical Stabilizer
11. Control Unit
12. Swashplate
(A) Airplane mode
(C) Closed Position
(H) Helicopter Mode
(O) Open Position
(T) Transition Mode

A hybrid air vehicle (1) comprises a body (2) on the air vehicle; at least one motor (3) which provides required power for the flight of the body (2); at least one rotor (4) extending outward from the body (2), connected to the motor (3), and rotating around itself; a plurality of blades (5) located on the rotor (4); a helicopter mode (H) in which the body (2) performs tasks such as vertical landing and take-off, autorotation and hovering; an anti-torque system (6) on the body (2), which creates anti-torque when the body (2) is in helicopter mode (H); an airplane mode (A) in which the rotor (4) is stopped and the blades (5) are used as fixed wings; at least one propulsion system (7) that provides thrust for the movement of the body (2) when the body (2) is in airplane mode (A); a transition mode (T) in which the rotor (4) is stopped and the propulsion system (7) is activated while the body (2) is switched from helicopter mode (H) to airplane mode (A); at least one canard (8) located in the nose area of the body (2) and providing force to the body (2) (FIG. 1).

The hybrid air vehicle (1) according to the invention comprises at least one control surface (9) located in the canard (8) to extend outwards from the canard (8); a closed position (C) in which the control surface (9) is located in the canard (8); an open position (O) in which the control surface (9) is moved from the closed position (C) and extends outward from the canard (8) when the body (2) is in helicopter mode (H), transition mode (T), or airplane mode (A) (FIG. 2).

During the movement of the body (2) in helicopter mode (H), the rotor (4) is stopped and the blades (5) are positioned to act as fixed wings, and the body (2) is switched into airplane mode (A). As the rotor (4) is stopped while switching from helicopter mode (H) to airplane mode (A), the lift applied to the body (2) by the blades (5) decreases. In order to solve this problem, canards (8) are placed in the front part of the body (2), so that the lift decreasing in the transition mode (T) is compensated to some extent.

Since the control surface (9), which is movably located in the canard (8), moves from the closed position (C) to the open position (O) and extends outwards from the body (2), it is triggered automatically or upon a user input in helicopter mode (H) and/or airplane mode (A) and/or transition mode (T) during a flight of the air vehicle, thereby providing additional lift to the body (2).

In an embodiment of the invention, the hybrid air vehicle (1) comprises the control surface (9) which extends telescopically from the closed position (C) through the canard (8) to the open position (O) only when the body (2) is in transition mode (T), thus providing additional lift to the body (2). When the rotor (4) is stopped, the lift acting on the body (2) provided by the blades (5) decreases. Only during transition mode (T) the control surface (9) is extended and additional lift is provided to the body (2) for a required period of time. In addition, when the transition to airplane mode (A) is completed, the control surface (9) can be closed when not required, since the lift by the blades (5) would be sufficient for flight.

In an embodiment of the invention, the hybrid air vehicle (1) comprises the control surface (9) moving along the direction that the canard (8) extends outward from the body (2) when the body (2) is in transition mode (T), such that the control surface (9) is switched from the closed position (C) to the open position (O), thereby increasing the aerodynamic surface area of the canard (8) and providing additional lift to the body (2). Thanks to the control surface (9) telescopically extending from the canard (8), the control surface (9) can be located in the canard (8) without occupying extra volume.

In an embodiment of the invention, the hybrid air vehicle (1) comprises the control surface (9) extending outward from the canard (8), rotating around the axis where it is attached to the canard (8), thereby acting as a flap on the body (2). The control surface (9) provides the flap function by being activated by the user over the trailing edge of the canard (8) in order to enable body (2) maneuvers during flight or to support fast maneuvers.

In an embodiment of the invention, the hybrid air vehicle (1) comprises at least one vertical stabilizer (10) that provides the anti-torque required by the body (2) in transition mode (T) and/or airplane mode (A) when the body (2) reaches flight values such as flight speed and altitude. As the flight speed of the hybrid air vehicle (1) increases, the vertical stabilizer (10) begins to provide sufficient anti-torque, and therefore the need for the anti-torque system (6) is eliminated.

In an embodiment of the invention, the hybrid air vehicle (1) comprises at least one control unit (11) that enables the body (2) to switch from helicopter mode (H) to airplane mode (A) according to the input by the user or when it reaches flight values such as flight speed and altitude predetermined by the user. Thanks to the control unit (11), during the flight, the hybrid air vehicle (1) is switched from helicopter mode (H) to airplane mode (A) depending on the required flight type, either automatically or by the user (FIG. 3, FIG. 5).

In an embodiment of the invention, the hybrid air vehicle (1) comprises the control unit (11) that moves, through telescopic movement, the control surface (9) from the closed position (C) to the open position (O) when the body (2) is in transition mode (T), and from the open position (O) to the closed position (C) when the body (2) is switched to airplane mode (A) or helicopter mode (H) (FIG. 4).

In an embodiment of the invention, the hybrid air vehicle (1) comprises the anti-torque system (6) which is moved on the body (2) in a direction providing thrust to the body (2) by means of the control unit (11), when the body (2) is switched from helicopter mode (H) to airplane mode (A). Therefore, in airplane mode (A), the anti-torque system (6), which does not need to apply anti-torque to the body (2) thanks to the vertical stabilizer (10), creates additional thrust for the flight of the hybrid air vehicle (1).

In an embodiment of the invention, the hybrid air vehicle (1) comprises the canard (8) which can rotate around itself during a flight, along an axis where it is attached to the body (2), thus allowing the body (2) to be directed. In this way, the canards (8) can also be used as an auxiliary system for the blades (5) to direct the body (2) during flight.

In an embodiment of the invention, the hybrid air vehicle (1) comprises a swashplate (12) that enables the body (2) to be controlled by changing the attack angles of the blades (5) when the blades (5) are in airplane mode (A). Since the swashplate (12) controls the blades (5) so that they can move in airplane mode (A), it provides additional lift and/or maneuverability capability by changing the angle of attack of the blades (5). In addition, the need for an additional control system on the body (2) to control the blades (5) used as fixed wings is eliminated.

In an embodiment of the invention, the hybrid air vehicle (1) comprises the blade (5) with an elliptical cross-section. Thanks to the blades (5) with elliptical cross-section, each surface of the blades (5) can serve as a fixed wing and provides the aerodynamic requirements to the body (2), which are required for airplane mode (A).

1. A hybrid air vehicle (1) comprising a body (2) on the air vehicle; at least one motor (3) which provides required power for the flight of the body (2) on the air vehicle; at least one rotor (4) extending outward from the body (2) on the air vehicle, connected to the motor (3), and rotating around itself; a plurality of blades (5) located on the rotor (4); a helicopter mode (H) in which the body (2) on the air vehicle performs tasks such as vertical landing and take-off, autorotation and hovering; an anti-torque system (6) on the body (2) on the air vehicle, which creates anti-torque when the body (2) on the air vehicle is in helicopter mode (H); an airplane mode (A) in which the rotor (4) is stopped and the blades (5) are used as fixed wings; at least one propulsion system (7) that provides thrust for the movement of the body (2) when the body (2) on the air vehicle is in airplane mode (A); a transition mode (T) in which the rotor (4) is stopped and the propulsion system (7) is activated while the body (2) on the air vehicle is switched from helicopter mode (H) to airplane mode (A); at least one canard (8) located in the nose area of the body (2) on the air vehicle and providing lift to the body (2) on the air vehicle, wherein at least one control surface (9) located in the canard (8) to extend outwards from the canard (8), control surface (9) that moves along the direction in which the wing (8) extends outward from the body (2) while the body (2) on the air vehicle is in transition mode (T) and thus moves from the closed position (C) to the open position (O), thus increasing the aerodynamic surface area of the wing (8) and providing additional load-bearing force to the body (2) on the air vehicle: a closed position (C) in which the control surface (9) is located in the canard (8); an open position (O) in which the control surface (9) is moved from the closed position (C) and extends outward from the canard (8) when the body (2) on the air vehicle is in helicopter mode (H), transition mode (T), or airplane mode (A).

2. A hybrid air vehicle (1) according to claim 1, wherein the control surface (9) which extends telescopically from the closed position (C) through the canard (8) to the open position (O) only when the body (2) on the air vehicle is in transition mode (T), thus providing additional lift to the body (2) on the air vehicle.

3. A hybrid air vehicle (1) according to claim 1, wherein the control surface (9) moving along the direction that the canard (8) extends outward from the body (2) when the body (2) is in transition mode (T), such that the control surface (9) is switched from the closed position (C) to the open position (O), thereby increasing the aerodynamic surface area of the canard (8) and providing additional lift to the body (2).

4. A hybrid air vehicle (1) according to claim 1, wherein the control surface (9) extending outward from the canard (8), rotating around the axis where it is attached to the canard (8), thereby acting as a flap on the body (2) on the air vehicle.

5. A hybrid air vehicle (1) according to claim 1, wherein at least one vertical stabilizer (10) that provides the anti-torque required by the body (2) on the air vehicle in transition mode (T) and/or airplane mode (A) when the body (2) on the air vehicle reaches flight values such as flight speed and altitude.

6. A hybrid air vehicle (1) according to claim 1, wherein at least one control unit (11) that enables the body (2) on the air vehicle to switch from helicopter mode (H) to airplane mode (A) according to the input by the user or when it reaches flight values such as flight speed and altitude predetermined by the user.

7. A hybrid air vehicle (1) according to claim 6, wherein the control unit (11) that moves, through telescopic movement, the control surface (9) from the closed position (C) to the open position (O) when the body (2) on the air vehicle is in transition mode (T), and from the open position (O) to the closed position (C) when the body (2) on the air vehicle is switched to airplane mode (A) or helicopter mode (H).

8. A hybrid air vehicle (1) according to claim 6, wherein the anti-torque system (6) which is moved on the body (2) in a direction providing thrust to the body (2) on the air vehicle by means of the control unit (11), when the body (2) on the air vehicle is switched from helicopter mode (H) to airplane mode (A).

9. A hybrid air vehicle (1) according to claim 1, wherein the canard (8) which can rotate around itself during a flight, along an axis where it is attached to the body (2) on the air vehicle, thus allowing the body (2) on the air vehicle to be directed.

10. A hybrid air vehicle (1) according to claim 1, wherein at least one swashplate (12) that enables the body (2) on the air vehicle to be controlled by changing the angles of attack of the blades (5) when the blades (5) are in airplane mode (A).

11. A hybrid air vehicle (1) according to claim 1, wherein the blade (5) with an elliptical cross-section.
